(19) United States
(12) Patent Application Publication
(10) Pub. No.: US 2022/0045418 A1
(43) Pub. Date: Feb. 10, 2022

(54) TOUCH SCREEN WITH BUILT-IN ANTENNA AND DISPLAY APPARATUS

(71) Applicant: Mitsubishi Electric Corporation, Tokyo (JP)

(72) Inventors: Tatsuya NAKAMURA, Kumamoto (JP); Takafumi HASHIGUCHI, Kumamoto (JP); Seiichiro MORI, Kumamoto (JP)

(73) Assignee: Mitsubishi Electric Corporation, Tokyo (JP)

(21) Appl. No.: 17/333,776

(22) Filed: May 28, 2021

(30) Foreign Application Priority Data
Aug. 5, 2020 (JP) 2020-133172

(51) Int. Cl. H01Q 1/22; G06F 3/044; H01Q 1/36; G06K 19/077

(52) U.S. Cl. CPC H01Q 1/2208; G06F 3/0446; G02F 1/13338; G06K 19/07773; H01Q 1/36

(57) ABSTRACT

An object of the present disclosure is to suppress reduction of a communication distance of a touch screen with a built-in antenna and obtain a high visual quality at a time of constituting a display apparatus by the touch screen. A touch screen with a built-in antenna of the present disclosure is provided on a side of an emission of display light of a display element. The touch screen with the built-in antenna includes a touch panel and an antenna pattern. The antenna pattern includes an antenna wire disposed to overlap with a detectable area in a plan view and made by a repetitive unit pattern. A second pitch which is a pitch of the unit pattern of the antenna wire is different from a first pitch which is a pitch of the unit pattern of each of the first detection wires and each of the second detection wires.

### BACKGROUND OF THE INVENTION

### Field of the Invention

The present disclosure relates to a touch screen provided with a built-in antenna for near field communication.

### Description of the Background Art

The non-contact integrated circuit (IC) card is provided with a built-in loop-like antenna coil and IC chip. Data can be transmitted and received via wireless communication by passing the non-contact IC card over a magnetic field generated by an IC card reader/writer. The non-contact IC card is used in entrance management at a ticket gate of a train or an entrance and exit management at a room, for example. A distance through which data can be read or written or a communication system is different in accordance with a type of the non-contact IC card.

An IC card reader/writer disposed separately from a display apparatus becomes mainstream currently. However, from a viewpoint of space reduction and improvement of design and usability, proposed is a display apparatus provided with a built-in near field communication antenna (also simply referred to as “the communication antenna” hereinafter) such as a near field communication (NFC) antenna and also functioning as an IC card reader/writer (refer to Japanese Patent Application Laid-Open No. 2012-064123, for example).

### SUMMARY

When a communication antenna is taken inside a liquid crystal display (LCD) as a case in a technique of Japanese Patent Application Laid-Open No. 2012-064123, a communication antenna is considered to be disposed on a rear surface of a display apparatus or between a reflection plate of a backlight and a rear frame to avoid an influence on display. In such a case, a backlight, an LCD, and a touch panel, for example, intervene between the communication antenna and the non-contact IC card, thus there is a problem that magnetic flux decreases and a communication distance is reduced compared with an IC card reader/writer provided separately from the display apparatus.

An object of a technique of the present disclosure is to suppress reduction of a communication distance of a touch screen with a built-in antenna and obtain a high visual quality at a time of constituting a display apparatus by the touch screen.

A touch screen with a built-in antenna of the present disclosure is provided on a side of an emission of display light of a display element. The touch screen with the built-in antenna of the present disclosure includes a touch panel and an antenna pattern. The antenna pattern is provided between the touch panel and the display element. The touch panel includes a plurality of first detection wires and a plurality of second detection wires. The plurality of first detection wires extend in a first direction. The plurality of second detection wires extend in a second direction which is different from the first direction, and sets a region where the plurality of second detection wires overlap with the plurality of first detection wires to a detectable area of the touch panel. Each of the first detection wires and each of the second detection wires are made by a repetitive unit pattern. The antenna pattern includes an antenna wire. The antenna wire is disposed to overlap with the detectable area of the touch panel in a plan view and made by a repetitive unit pattern. A second pitch which is a pitch of the unit pattern of the antenna wire is different from a first pitch which is a pitch of the unit pattern of each of the first detection wires and each of the second detection wires.

The display element does not intervene between the antenna pattern of the touch screen with the built-in antenna of the present disclosure and a non-contact IC card, thus reduction in a communication distance is suppressed. The pitch of the unit pattern of the first detection wire and the second detection wire of the touch panel and the pitch of the unit pattern of the antenna wire are different from each other, thus an opening region of each wire when viewed from a side of a surface of the touch panel is ununiformly distributed, and an occurrence of a moire is suppressed. The antenna pattern can be disposed on any region on a side of a rear surface of the touch panel without a limitation of a wire pattern of the touch panel.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating a layer structure of a touch screen with a built-in antenna of an embodiment 1.

FIG. 2 is a cross-sectional view illustrating a configuration of the touch screen with the built-in antenna of the embodiment 1.

FIG. 3 is a plan view illustrating a configuration of the touch screen with the built-in antenna of the embodiment 1.

FIG. 4 is an enlarged view of an electrode and a wire of a touch panel in a region A in FIG. 3 in the touch screen with the built-in antenna of the embodiment 1.

FIG. 5 is an enlarged view of an antenna pattern in the region A in FIG. 3 in the touch screen with the built-in antenna of the embodiment 1.

FIG. 6 is an enlarged view of a touch panel surface and an antenna surface in the region A in FIG. 3 in the touch screen with the built-in antenna of the embodiment 1.

FIG. 7 is an enlarged view of the touch panel surface in a region B in FIG. 4 in the touch screen with the built-in antenna of the embodiment 1.

FIG. 8 is an enlarged view of the antenna surface in a region C in FIG. 5 in the touch screen with the built-in antenna of the embodiment 1.

FIG. 9 is an enlarged view of the touch panel surface and the antenna surface in a region D in FIG. 6 in the touch screen with the built-in antenna of the embodiment 1.

FIG. 10 is an enlarged view of the touch panel surface in a region B in FIG. 4 in the touch screen with the built-in antenna of an embodiment 2.

FIG. 11 is an enlarged view of an antenna surface in a region C in FIG. 5 in a touch screen with a built-in antenna of the embodiment 2.

FIG. 12 is an enlarged view of the touch panel surface and the antenna surface in a region D in FIG. 6 in the touch screen with the built-in antenna of the embodiment 2.

### DESCRIPTION OF THE PREFERRED EMBODIMENTS

### A. Embodiment 1

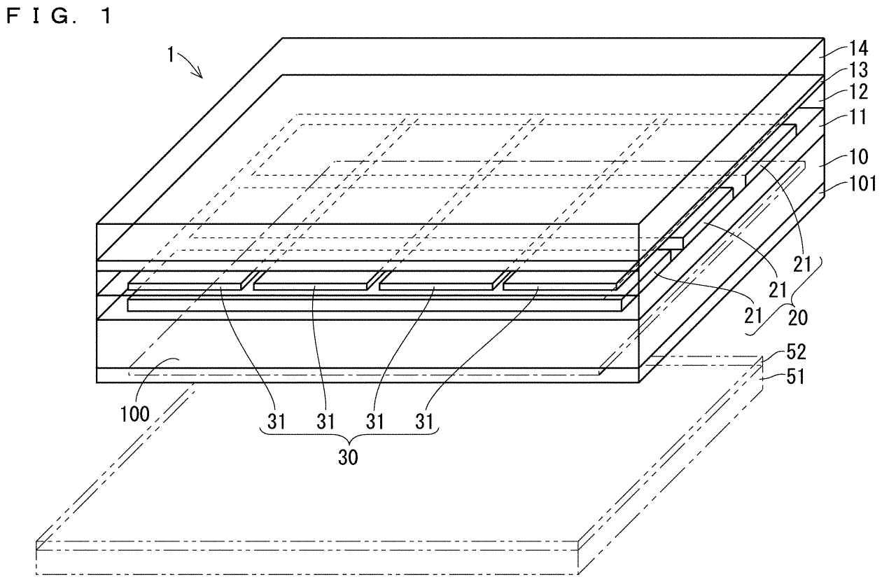

A touch screen with a built-in antenna 1 of an embodiment is described firstly using FIG. 1 to FIG. 9. In the description, the touch screen with the built-in antenna 1 of the embodiment 1 is a projected capacitive touch screen, but is not limited thereto.

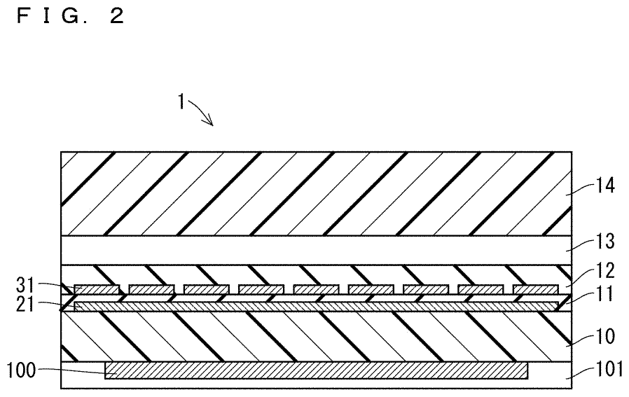

FIG. 1 is a perspective view illustrating a layer structure of the touch screen with the built-in antenna 1. FIG. 2 is a cross-sectional view illustrating a configuration of the touch screen with the built-in antenna 1. As illustrated in FIGS. 1 and 2, a lowermost surface layer of the touch screen with the built-in antenna 1 is a transparent substrate 10 made of a transparent glass material or a transparent resin. A lower electrode 20 is disposed on the transparent substrate 10. An interlayer insulating film 11 is disposed to cover the lower electrode 20. The interlayer insulating film 11 is a transparent insulating film such as a silicon nitride film or a silicon oxide film. An upper electrode 30 is disposed on an upper surface of the interlayer insulating film 11.

Furthermore, a protective film 12 is disposed on the upper surface of the interlayer insulating film 11 to cover the upper electrode 30. A protection film 12 is an insulative film having translucency such as a silicon nitride film as with the interlayer insulating film 11. An adhesive material 13 is disposed on an upper surface of the protection film 12. A transparent substrate 14 constituting a surface of the touch screen with the built-in antenna 1 is bonded to an upper surface of the adhesive material 13 by the adhesive material 13 to protect the touch screen with the built-in antenna 1. For example, a transparent glass material or a transparent resin is applied to the transparent substrate 14.

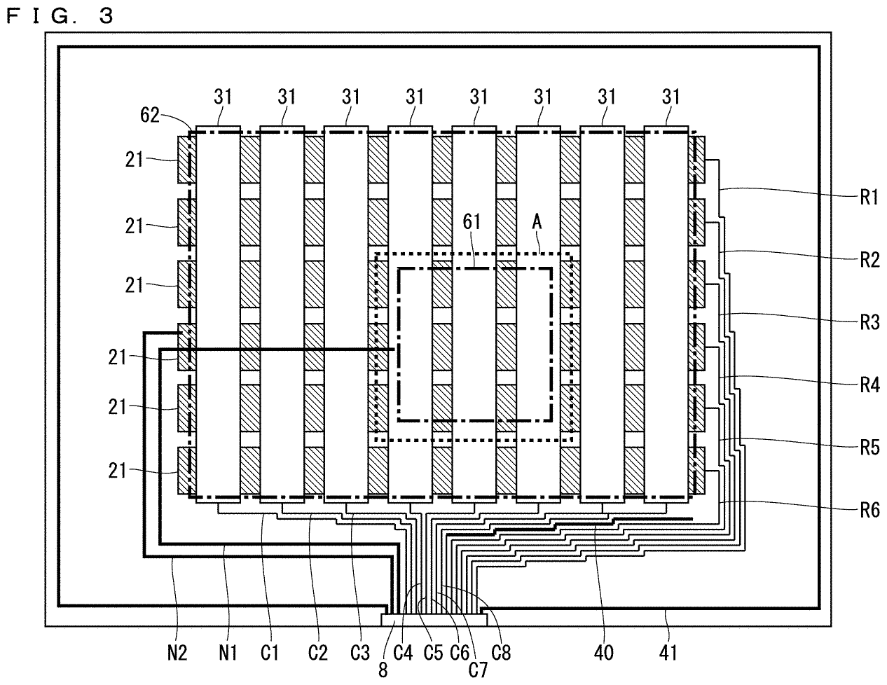

An antenna pattern 100 is disposed below the transparent substrate 10. That is to say, the antenna pattern 100 is disposed to overlap with a detectable area of a touch panel described hereinafter in a plan view. The antenna pattern 100 illustrated in FIG. 2 includes an antenna wire 61 and a dummy electrode 62 formed into the same shape as the antenna wire 61 illustrated in FIG. 3. The dummy electrode 62 may be included in a different layer from or the same layer as the antenna wire 61, however, the same layer is preferable in a viewpoint of visibility. When the dummy electrode 62 is formed of the same material as the antenna wire 61, the visibility is further improved. A protection film 101 is disposed to cover the antenna pattern 100 (refer to FIG. 2).

The lower electrode 20 includes a plurality of row direction wires 21, and the upper electrode 30 includes a plurality of column direction wires 31. Each row direction wire 21 and each column direction wire 31 are made up of a transparent conductive film such as indium tin oxide (ITO) or a metal wire material such as aluminum or copper, for example. The antenna wire 61 and the dummy electrode 62 in the antenna pattern 100 (refer to FIG. 3) are made up of a metal wire material such as aluminum or copper, for example. When a multilayer structure made up of an aluminum alloy layer and a nitrided layer thereof is applied to each row direction wire 21, each column direction wire 31, the antenna wire 61, and the dummy wire 62, wiring resistance can be reduced, and a reflection ratio of light in the detectable area can be reduced.

In the embodiment 1, the column direction wire 31 is disposed on the row direction wire 21, however, it is also applicable that a position relationship thereof is reversed and row direction wire 21 is disposed on column direction wire 31. Alternatively, it is also applicable that the row direction wire 21 and the column direction wire 31 are disposed in the same layer, and the interlayer insulating film 11 is disposed only in a portion between the row direction wire 21 and the column direction wire 31 where these wires overlap with each other in a plan view, and these wires are electrically separated from each other.

Furthermore, the materials of the column direction wire 31 and the row direction wire 21 are unified to have the multilayer structure made up of the aluminum alloy layer and the nitrided layer thereof, however, these materials may not be unified. For example, it is also applicable that the material of the column direction wire 31 has a multilayer structure made up of an aluminum alloy layer and a nitrided layer thereof and the row direction wire 21 is made up of a transparent conductive film such as ITO.

A user touches the transparent substrate 14 constituting the surface of the touch screen with the built-in antenna 1 with an indicator such as a finger to perform an operation. When the indicator touches the transparent substrate 14, capacity coupling (touch capacitance) occurs between the indicator and at least one of the row direction wire 21 and the column direction wire 31 below the transparent substrate 14. Mutual capacitance system has a configuration that a position touched by the indicator in the detectable area is specified based on a change of a mutual capacitance between row direction wire 21 and column direction wire 31 occurring in accordance with occurrence of the touch capacitance.

The row direction wire 21 and the column direction wire 31 constitute the touch panel in this manner. In other words, the touch panel includes the plurality of row direction wires 21 which are the plurality of first detection wires extending in the row direction which is the first direction and the plurality of column direction wires 31 which are the plurality of second detection wires extending in the second direction different from the first direction and sets the region where the column direction wire 31 overlap with the plurality of row direction wires 21 to the detectable area of the touch panel.

Not only the touch screen with the built-in antenna 1 but also a display element 51 and an adhesive material 52 are illustrated by an imaginative line (dashed-two dotted line) in FIG. 1. The touch screen with the built-in antenna 1 and the display element 51 are joined by the adhesive material 52, thereby constituting the display apparatus. For example, a liquid crystal element or a display panel such as an liquid crystal display (LCD) panel is applied to the display element 51. The touch screen with the built-in antenna 1 is provided on a side of an emission of display light of the display element 51.

FIG. 3 is a plan view illustrating a configuration of the touch screen with the built-in antenna 1 of the embodiment 1. The detectable area of the touch screen with the built-in antenna 1 is a matrix region formed by the overlap of the plurality of row direction wires 21 extending in a lateral direction (row direction) and the plurality of column direction wires 31 extending in a vertical direction (column direction) in a plan view. In the description hereinafter, a plurality of sensor wires extending along a predetermined extension direction are the row direction wires 21, and the detectable area is an arrangement region of the row direction wires 21. However, the configuration is not limited thereto, but the column direction wire 31 may be applied in place of the row direction wire 21 or both the row direction wire 21 and the column direction wire 31 may also be applied.

Each of the row direction wires 21 is connected to a terminal 8, which is used to be connected to an external wire, by leading wires R1 to R6. In the similar manner, each of the column direction wires 31 is connected to the terminal 8, which is used to be connected to an external wire, by leading wires C1 to C8.

The antenna wire 61 is connected to the terminal 8, which is used to be connected to an external wire, by a leading wire N1. The dummy electrode 62 is connected to the terminal 8, which is used to be connected to an external wire, by a leading wire N2.

In the embodiment 1, the touch screen with the built-in antenna 1 includes one antenna pattern 100, but may include the plurality of antenna patterns 100.

The leading wires R1 to R6 are connected to terminal parts of the row direction wires 21, respectively, and extend along an outer periphery of the detectable area. Herein, when the leading wire R5 reaches the leading wire R6 in an outer periphery direction of the detectable area, the leading wire R5 extends along the leading wire R6 on an outer side of the leading wire R6 (a side opposite to the detectable area). The leading wires R1 to R4 are also disposed in the manner similar to the leading wire R5.

In the embodiment 1, the leading wires R1 to R6 are disposed close to a side of the outer periphery of the detectable area. In the similar manner, the leading wires C1 to C8 are disposed close to the side of the outer periphery of the detectable area in order of increasing distance of the leading wire from the terminal 8. The leading wires R1 to R6 and C1 to C8 are disposed as close to the side of the outer periphery of the detectable area as possible, thus a fringe capacitance between the display element 51 to which the touch screen with the built-in antenna 1 is attached and the leading wires R2 to R6 and C2 to C8 except the leading wires R1 and C2 can be suppressed.

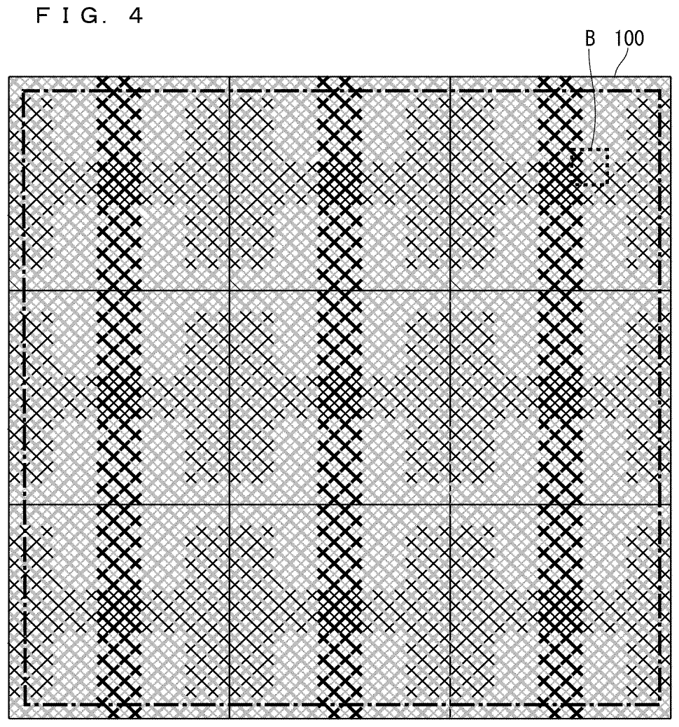

FIG. 4 is an enlarged view of an electrode and a wire of the touch panel in a region A in the touch screen with the built-in antenna 1 illustrated in FIG. 3. The touch panel includes the lower electrode 20 and the upper electrode 30. The lower electrode 20 includes the plurality of row direction wires 21 each connected to predetermined potential and a plurality of floating electrodes 22 which are not connected to any potential. The floating electrode 22 is a first floating electrode provided in the same layer as the row direction wire 21 and insulated from the row direction wire 21.

The upper electrode 30 includes the plurality of column direction wires 31 each connected to predetermined potential and a plurality of floating electrodes 32 which are not connected to any potential. The floating electrode 32 is a second floating electrode provided in the same layer as the column direction 31 wire and insulated from the column direction wire 31.

The row direction wire 21, the floating electrode 22, the column direction wire 31, and the floating electrode 32 are also collectively referred to as a touch panel surface. The plurality of row direction wires 21 are divided from the plurality of floating electrodes 22 at a boundary, thus are not connected to each other. The floating electrodes 22 are connected to each other. The plurality of column direction wires 31 are divided from the plurality of floating electrodes 32 at a boundary, thus are not connected to each other. The floating electrodes 32 are connected to each other. A unit pattern of each of the row direction wire 21, the floating electrode 22, the column direction wire 31, and the floating electrode 32 has the same shape.

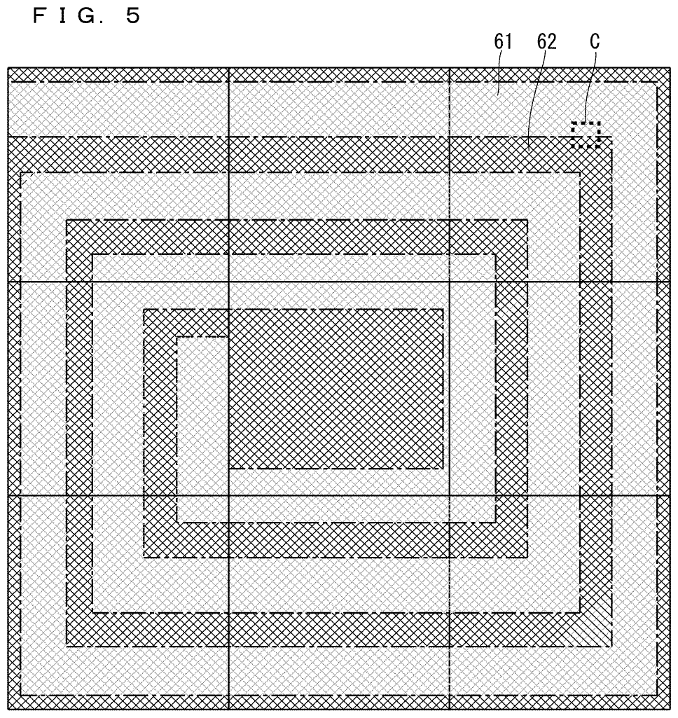

FIG. 5 is an enlarged view of the antenna pattern 100 in the region A in the touch screen with the built-in antenna 1 illustrated in FIG. 3. The antenna pattern 100 is also referred to as an antenna surface hereinafter. Each of the antenna wire 61 and the dummy electrode 62 is connected to predetermined potential. The antenna wire 61 and the dummy electrode 62 are divided at a boundary and are not connected to each other. The dummy electrode 62 needs to be connected to the predetermined potential, thus each dummy electrode 62 is connected. A unit pattern of the antenna wire 61 and the dummy electrode 62 has the same shape. The dummy electrode 62 is provided to fill a display region where the antenna wire 61 is not disposed.

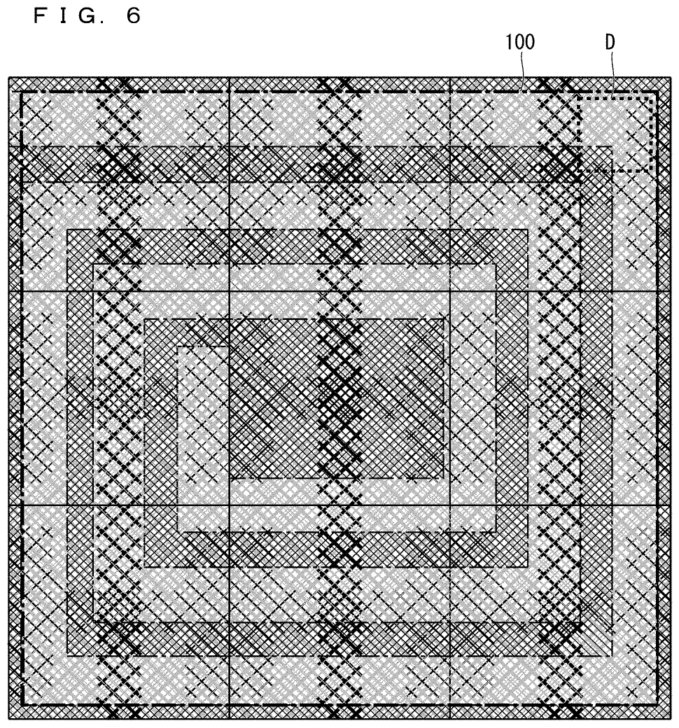

FIG. 6 is an enlarged view of the touch panel surface and the antenna surface in the region A in the touch screen with the built-in antenna 1 illustrated in FIG. 3. FIG. 6 corresponds to a drawing made up of FIG. 4 and FIG. 5 overlapping with each other.

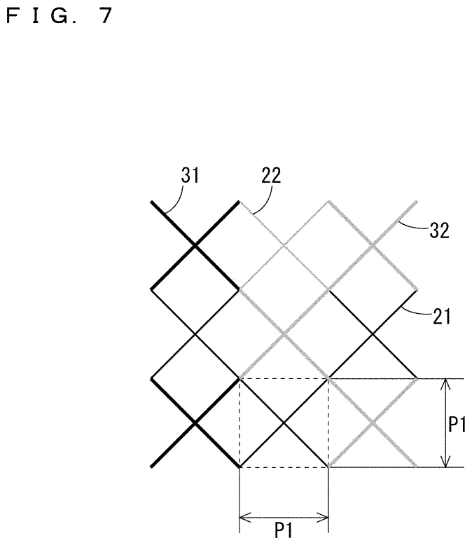

FIG. 7 is an enlarged view of the touch panel surface in a region B in FIG. 4. As illustrated in FIG. 7, a pitch of the unit pattern of the row direction wire 21 constituting the touch panel, the floating electrode 22, the column direction wire 31, and the floating electrode 32 is P1. The pitch of the unit pattern of the row direction wire 21 and the column direction wire 31 constituting the touch panel is also referred to as the first pitch. In the embodiment 1, the pitch of the unit pattern of each of the row direction wire 21, the floating electrode 22, the column direction wire 31, and the floating electrode 32 is the same as each other, but may also not be the same.

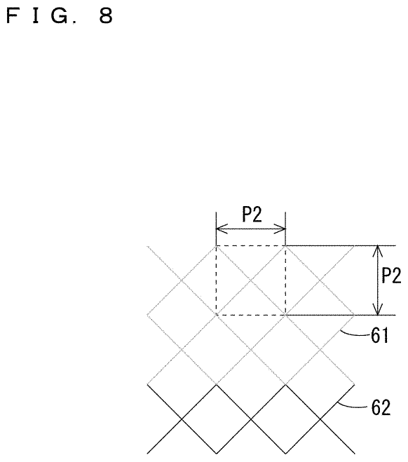

FIG. 8 is an enlarged view of the antenna surface in a region C in FIG. 5. As illustrated in FIG. 8, the second pitch which is the pitch of the unit pattern of the antenna wire 61 is P2. In FIG. 8, the pitch of the unit pattern of the dummy electrode 62 is the same as the pitch of the unit pattern of the antenna wire 61, but may also be different from each other.

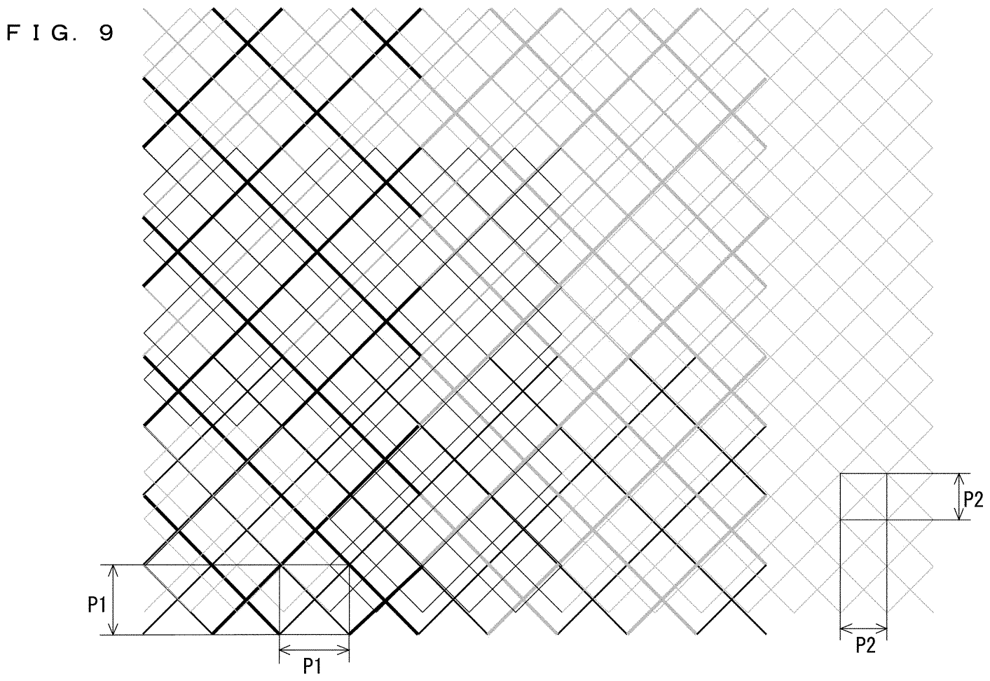

FIG. 9 is an enlarged view of the touch panel surface and the antenna surface in a region D in FIG. 6. In FIG. 9, the pitch P1 of the unit pattern of the touch panel surface is larger than the pitch P2 of the unit pattern of the antenna surface, but may also be smaller than the pitch P2. The pitch P1 of the unit pattern of the touch panel surface and the pitch P2 of the unit pattern of the antenna surface are selected so that one of them does not fall under a multiple number or a submultiple of the other one of them. Accordingly, an opening region of a metal wire of the touch panel surface and the antenna surface is ununiformly distributed in a plan view, thus a moire is suppressed.

When the pitch P1 of the unit pattern of the touch panel surface and the pitch P2 of the unit pattern of the antenna surface are the same as each other, there is concern that the moire occurs in accordance with a thickness of the transparent base material, and the resistance of the antenna wire 61 is hardly reduced, so that antenna performance is worsened. However, in the touch screen with the built-in antenna 1 in the embodiment 1, the pitch P2 of the unit pattern of the antenna surface is not limited by the pitch P1 of the unit pattern of the touch panel surface, and can be made smaller than the pitch P1 of the unit pattern of the touch panel surface, thus the resistance of the antenna wire 61 can be reduced.

In the touch screen with the built-in antenna 1 of the embodiment 1, the region of the antenna pattern 100 other than the antenna wire 61 is filled with the dummy electrode 62. Thus, a space frequency is equalized in the whole region of the antenna pattern 100, and a boundary between the antenna wire 61 and the dummy electrode 62 is hardly visually recognized, and a visual quality is increased. Accordingly, a size and a shape of the antenna pattern 100 can be freely set in the display region of the touch screen with the built-in antenna 1.

The display element 51 has a plurality of pixels arranged in a row direction and a column direction. The display element 51 is disposed so that the display region thereof overlaps with the detectable area of the touch screen with the built-in antenna 1 and substantially coincides with the detectable area in a plan view. Accordingly, a pattern of each wire and each electrode of the touch panel surface and the antenna surface of the touch screen with the built-in antenna 1 is disposed in an oblique direction inclined at an angle of 45 degrees with respect to an arrangement direction (row direction or column direction) of the pixel of the display element 51, and uniformly covers part of each pixel. Accordingly, according to the configuration of the embodiment 1, transmissivity of the display light passing through the touch screen with the built-in antenna 1 after being emitted from the display element 51 is unified, and the moire is suppressed.

The row direction wire 21, the column direction wire 31, the antenna wire 61, and the dummy electrode 62 are formed into a mesh-like shape, thereby being able to cover a wide detectable area by a small wire area. However, the materials and the shapes, for example, of the row direction wire 21, the column direction wire 31, the antenna wire 61, and the dummy electrode 62 are not limited to those in the above description.

A transparent conductive material such as ITO or graphene or a metal material such as aluminum, chrome, copper, or silver can be used as the materials of the row direction wire 21 and the column direction wire 31. A multilayer structure of an alloy of aluminum, chrome, copper, or silver or aluminum nitride formed on such an alloy, for example, can be used as the metal materials of the row direction wire 21 and the column direction wire 31. Widths and mesh intervals of the row direction wire 21 and the column direction wire 31 can be appropriately changed in accordance with a purpose of usage of the touch screen with the built-in antenna 1.

A metal material such as aluminum, chrome, copper, or silver can be used as the materials of the antenna wire 61 and the dummy electrode 62. A multilayer structure of an alloy of aluminum, chrome, copper, or silver or aluminum nitride formed on such an alloy, for example, can be used as the metal materials of the antenna wire 61 and the dummy electrode 62. Widths and mesh intervals of the antenna wire 61 and the dummy electrode 62 can be appropriately changed in accordance with a purpose of usage of the touch screen with the built-in antenna 1.

The antenna wire 61 is connected to an antenna terminal (not shown) by a leading wire. The antenna terminal is connected to a reader/writer substrate. A switch is provided between the antenna terminal and the reader/writer substrate. When the switch is in an ON state, that is to say, when a signal is supplied to the antenna wire 61 by the reader/writer substrate and a near field communication function is operated by the antenna wire 61, the touch screen with the built-in antenna 1 stops a touch panel operation.

When the touch screen with the built-in antenna 1 detects the mutual capacitance of the touch panel, the touch screen with the built-in antenna 1 applies GND potential to the antenna wire 61 and the dummy electrode 62. When the touch screen with the built-in antenna 1 detects the self-capacitance of the touch panel, the touch screen with the built-in antenna 1 applies the same shield signal as an excitation signal to the antenna wire 61 and the dummy electrode 62, thereby preventing an influence of disturbance noise of a display apparatus, for example, and suppressing an erroneous operation of the touch screen.

According to the touch screen with the built-in antenna 1 of the embodiment 1 described above, the antenna pattern can be formed without a limitation of the touch panel pattern, and a preferable communication environment can be proposed.

### B. Embodiment 2

A touch screen with a built-in antenna of an embodiment 2 is different from the touch screen with the built-in antenna of the embodiment 1 only in that a unit pattern of each wire or each electrode constituting a touch panel surface and an antenna surface has an arc shape, and the other basic configuration is as illustrated in FIG. 1 to FIG. 6.

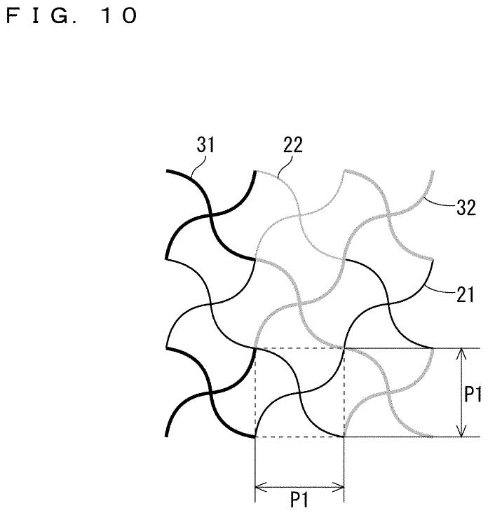

FIG. 10 is an enlarged view of a touch panel surface of the touch screen with the built-in antenna of the embodiment 2 corresponding to the region B in FIG. 4.

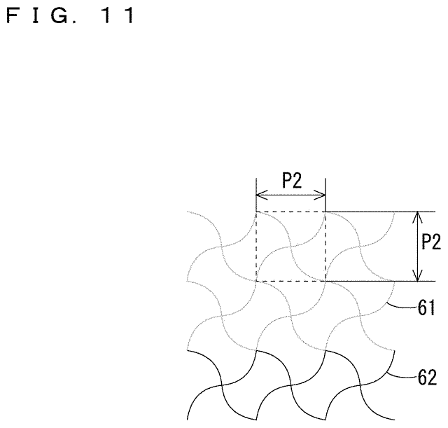

FIG. 11 is an enlarged view of the antenna surface corresponding to the region C in FIG. 5.

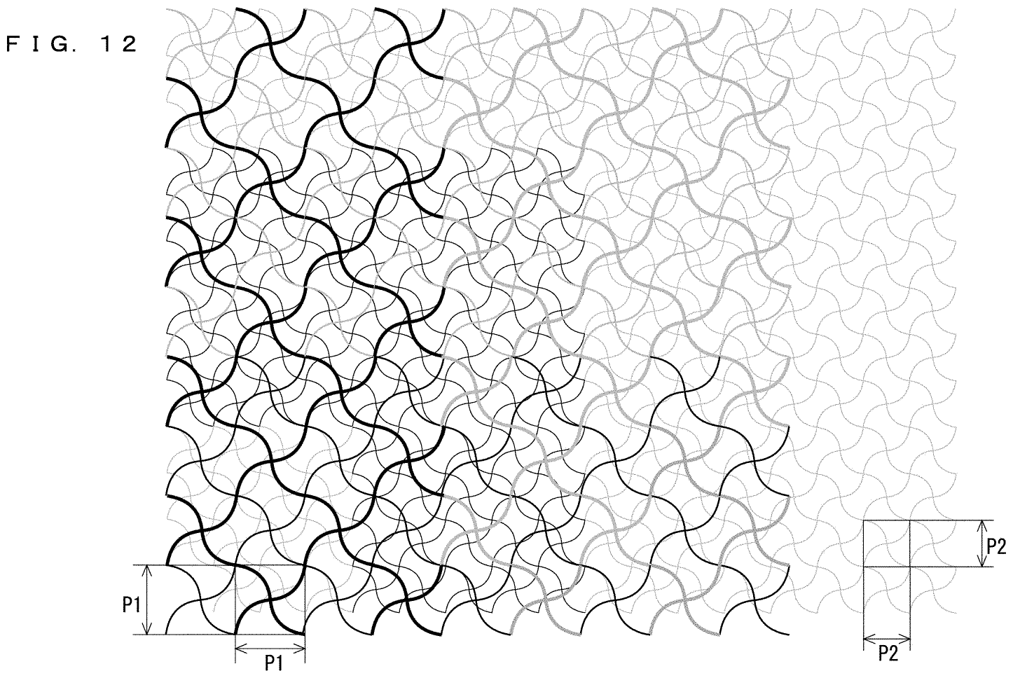

FIG. 12 is an enlarged view of the touch panel surface and the antenna surface corresponding to the region D in FIG. 6.

In the touch screen with the built-in antenna of the embodiment 2, the unit pattern of each wire or each electrode constituting the touch panel surface and the antenna surface has the arc shape, thus an opening region of a metal wire of the touch panel surface and the antenna surface is further ununiformly distributed in a plan view, and the occurrence of the moire is suppressed. In each wire or each electrode constituting the touch panel surface and the antenna surface, at least part of the unit patterns thereof may have the arc shape, or all of the unit patterns may have the arc shape.

According to the touch screen with the built-in antenna of the embodiment 2 described above, the occurrence of the moire can be further suppressed in addition to the effect of the embodiment 1.

Each embodiment can be arbitrarily combined, or each embodiment can be appropriately varied or omitted.

While the invention has been shown and described in detail, the foregoing description is in all aspects illustrative and not restrictive. It is therefore understood that numerous modifications and variations can be devised without departing from the scope of the invention.

What is claimed is:

1. A touch screen with a built-in antenna provided on a side of an emission of display light of a display element, comprising:
a touch panel; and
an antenna pattern provided between the touch panel and the display element, wherein
the touch panel includes:
a plurality of first detection wires extending in a first direction; and
a plurality of second detection wires extending in a second direction which is different from the first direction, and setting a region where the plurality of second detection wires overlap with the plurality of first detection wires to a detectable area of the touch panel, wherein
each of the first detection wires and each of the second detection wires are made by a repetitive unit pattern,
the antenna pattern includes
an antenna wire disposed to overlap with the detectable area of the touch panel in a plan view and made by a repetitive unit pattern, and
a second pitch which is a pitch of the unit pattern of the antenna wire is different from a first pitch which is a pitch of the unit pattern of each of the first detection wires and each of the second detection wires.

2. The touch screen with the built-in antenna according to claim 1, wherein
the second pitch is neither a multiple number or a submultiple of the first pitch.

3. The touch screen with the built-in antenna according to claim 1, wherein
the second pitch is smaller than the first pitch.

4. The touch screen with the built-in antenna according to claim 1, wherein
each of the first detection wires and each of the second detection wires are made up of a transparent conductive film.

5. The touch screen with the built-in antenna according to claim 1, wherein
the touch panel includes:
a first floating electrode provided in a layer identical with the first detection wires and insulated from the first detection wires; and
a second floating electrode provided in a layer identical with the second detection wires and insulated from the second detection wires.

6. The touch screen with the built-in antenna according to claim 1, wherein
the antenna pattern is provided in a region where the antenna wire is not disposed, and includes a dummy electrode insulated from the antenna wire.

7. The touch screen with the built-in antenna according to claim 1, wherein
at least part of unit patterns of each of the first detection wires, each of the second detection wires, and the antenna wire has an arc shape.

8. The touch screen with the built-in antenna according to claim 7, wherein
unit patterns of all of the first detection wires, the second detection wires, and the antenna wire have an arc shape.

9. A display apparatus, comprising:
the touch screen with the built-in antenna according to claim 1; and
the display element.
